(19) United States
(12) Patent Application Publication
(10) Pub. No.: US 2021/0344135 A1
(43) Pub. Date: Nov. 4, 2021

(54) Retaining System For DMC-M Low Profile Modules

(71) Applicant: Connecteurs Electriques Deutsch, Evreux (FR)

(72) Inventor: Jean-Luc Moreau, Evreux (FR)

(73) Assignee: Connecteurs Electriques Deutsch, Evreux (FR)

(21) Appl. No.: 17/243,759

(22) Filed: Apr. 29, 2021

(30) Foreign Application Priority Data
Apr. 30, 2020 (EP) 20305416.8

(51) Int. Cl. H01R 13/426; H01R 13/514; H01R 12/72; H01R 13/04

(52) U.S. Cl. CPC H01R 13/426; H01R 13/04; H01R 12/724; H01R 13/514

(57) ABSTRACT

An assembly includes an electrical connector module to be mounted into a cavity of a housing and a clipping bar securing the electrical connector module when mounted in the cavity. The clipping bar is inserted into a trench of the housing and abuts against a clipping lug of the electrical connector module. The clipping bar is releasably secured in the trench.

### CROSS-REFERENCE TO RELATED APPLICATIONS

This application claims the benefit of the filing date under 35 U.S.C. § 119(a)-(d) of European Patent Application No. 20305416.8, filed on Apr. 30, 2020.

### FIELD OF THE INVENTION

The present invention relates to an electrical connector and, more particularly, to an electrical connector module.

### BACKGROUND

Electrical connectors, in particular DMC-M Low Profile Modules, are known as connectors used in automobile applications, aerospace systems, etc. for providing compact, lightweight connectivity. Often, these connectors are angled due to space limitations. These connectors may provide connections between printed circuit boards (PCB) and mating housings, e.g. of other electrical elements, outside the PCB.

There is, however, a problem that said electrical connectors, once plugged into said mating housings, are very difficult to unplug. In other words, it is often hardly possible to unplug and eventually remove a low profile module from a cavity of a mating housing after it has been plugged into said cavity of the mating housing, because fit-on or snap-on elements are too rigid to be removed from their respective snap-on grooves, even with tooling. In addition, elements of the electrical connector may be hardly accessible at all due to the angled shape and thus angled contacts of the connector.

### SUMMARY

An assembly includes an electrical connector module to be mounted into a cavity of a housing and a clipping bar securing the electrical connector module when mounted in the cavity. The clipping bar is inserted into a trench of the housing and abuts against a clipping lug of the electrical connector module. The clipping bar is releasably secured in the trench.

### BRIEF DESCRIPTION OF THE DRAWINGS

The invention will now be described by way of example with reference to the accompanying Figures, of which:

FIG. 1 is a sectional perspective view of an electrical connector module according to an embodiment;

FIG. 2 is a side view of the electrical connector module of FIG. 1 attached to a printed circuit board;

FIG. 3 is a perspective view of attaching the electrical connector modules of FIG. 1 to a printed circuit board;

FIG. 4a is a perspective view of the electrical connector module of FIG. 3 attached to a base;

FIG. 4b is a sectional side view of the sub-assembly of FIG. 4a;

FIG. 5a is a perspective view of the sub-assembly of FIG. 4b with a clipping bar;

FIG. 5b is a detail sectional side view of the sub-assembly and the clipping bar of FIG. 5a;

FIG. 5c is a sectional side view of the sub-assembly and the clipping bar of FIG. 5a;

FIG. 6 is a perspective view of a clipping bar according to two different embodiments;

FIG. 7a is a perspective view of the sub-assembly of FIG. 5a fit into a frame as a retaining part to form an assembly;

FIG. 7b is a perspective view of the assembly of FIG. 7a;

FIG. 8 is a sectional side view of the assembly of FIG. 7b;

FIG. 9 is an exploded perspective view of the assembly and clipping bars according to another embodiment; and

FIG. 10 is a sectional side view of releasing and unhooking the electrical connector module from a cavity of a housing.

### DETAILED DESCRIPTION OF THE EMBODIMENT(S)

Further features and advantages will become apparent from the following more particular description of the various embodiments of the present disclosure, as illustrated in the accompanying drawings, in which like references refer to like elements. In the following, it should be understood that same elements are denoted by same reference signs, the explanation of which would then only be repeated where necessary.

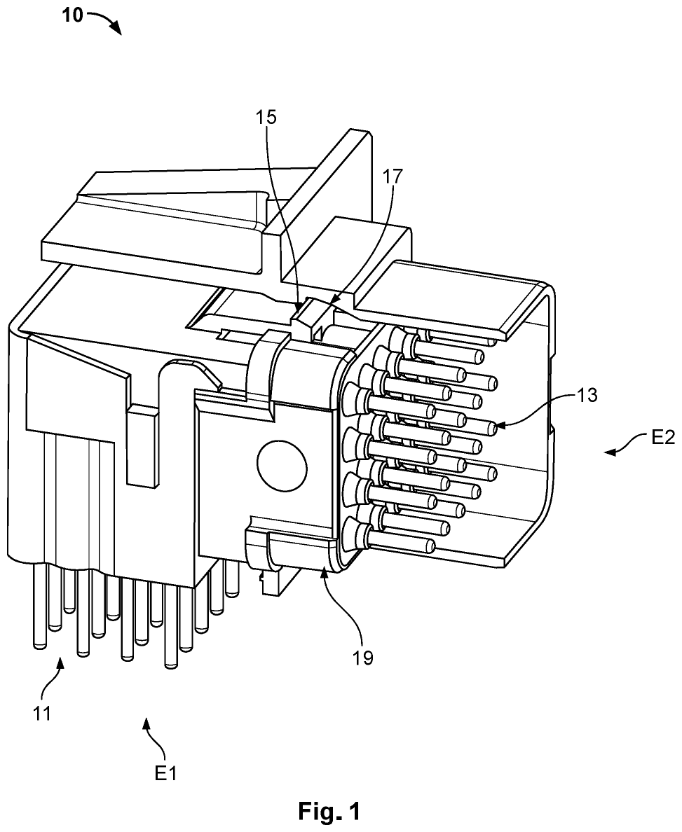

FIG. 1 illustrates an electrical connector module, e.g. a low profile module 10. The module 10 shown in FIG. 1 is an angled module. Module 10 has ends with connectors or contacts E1 and E2, respectively, which are angled at 90 deg. Module 10 has angled first contacts 11. The modular electrical connector/electrical connector module 10 further has second contacts 13. Module has a clipping groove 15 with an upper clipping lug 17 and a lower clipping lug 19. Lower clipping lug 19 would have a corresponding clipping groove 15, similar to upper clipping lug 17, which however is not visible in FIG. 1.

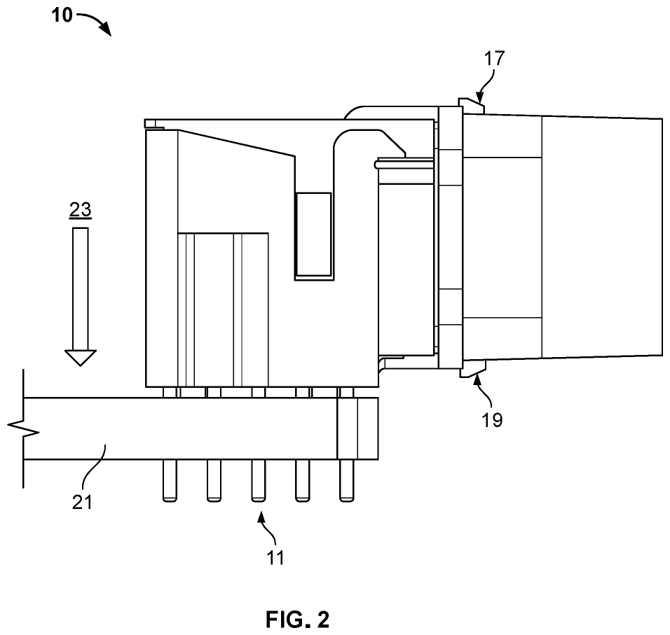

FIG. 2 illustrates the electrical connector module 10 of FIG. 1, as it is attached to a printed circuit board 21. The arrow 23 indicates the direction of fitting the one end, E1, of the module 10 on the printed circuit board 21. Attachment of the electrical connector module 10 to the printed circuit board 21 may be achieved by, e.g., soldering.

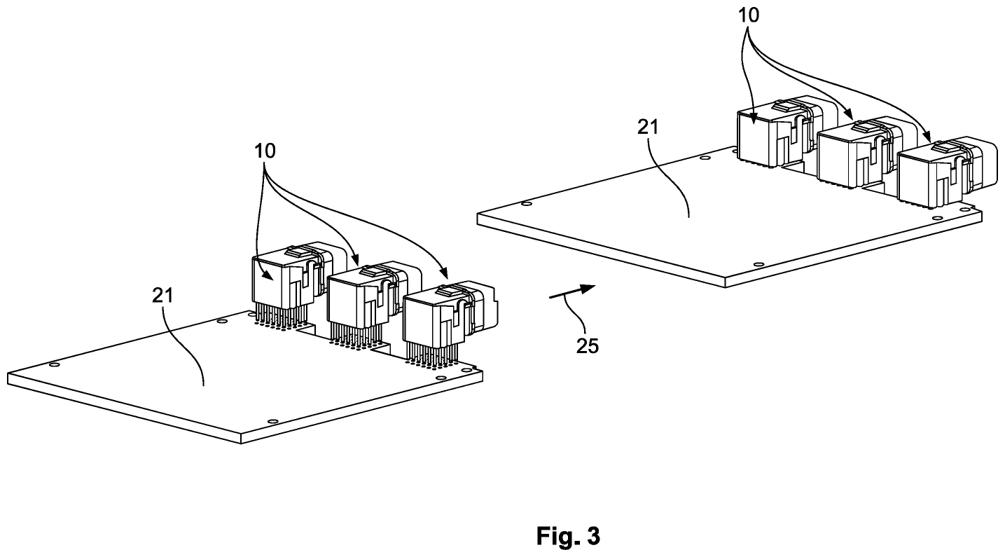

FIG. 3 illustrates attaching electrical connector modules 10 as shown in FIGS. 1 and 2 to the printed circuit board 21. FIG. 3 shows three electrical connector modules 10 on the printed circuit board 21. It should be understood that more than one electrical connector module 10, e.g. two or three connectors, may be used. As for FIGS. 1 and 2, these may be low profile modules, e.g. DMC-M LP modules. The arrow 25 of FIG. 3 indicates the development of the process.

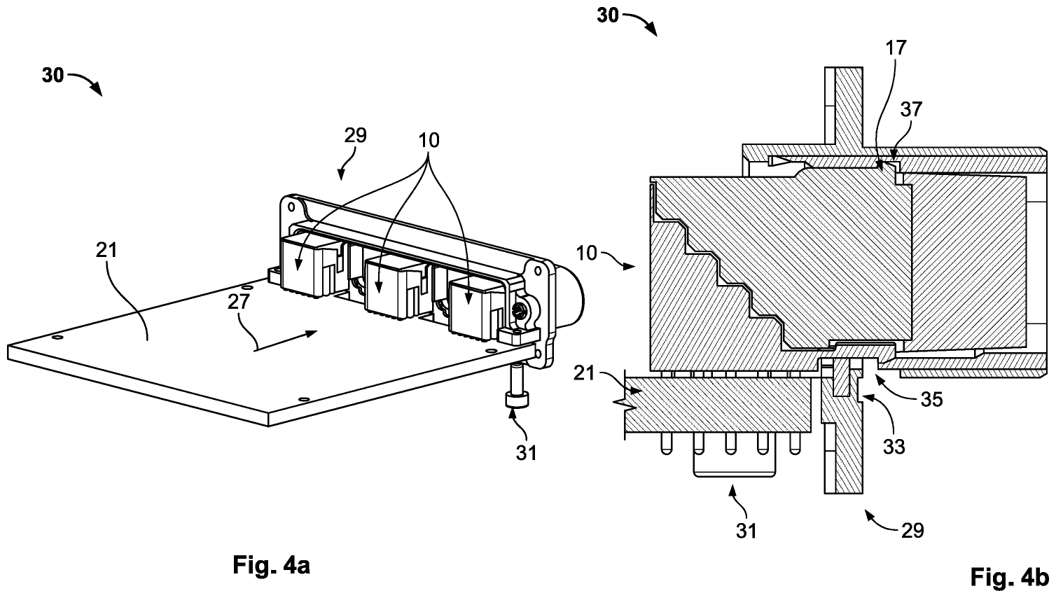

FIG. 4a illustrates electrical connector module 10 attached to a printed circuit board 21, as shown in FIG. 3, now attached to a base 29. The arrow 27, largely parallel to the surface of the printed circuit board 21, indicates the direction of fitting together the printed circuit board 21, carrying the modules 10, and the base 29. Due to the angled nature of the modules 10, the main direction of the base 29 is now roughly perpendicular to the surface of the printed circuit board 21. These directions should be understood mostly for orientation purposes. The base 29 may be attached or connected to the printed circuit board 21 by screws 31. For example, one or more, in particular two screws 31 may be used to attach the base 29 to the printed circuit board 21. By this connection or attachment, the printed circuit board 21, the base 29, and the modules 10 form a sub-ensemble or sub-assembly 30, according to the present disclosure. In an embodiment, one end of the modular electrical connector 10 may be soldered into a printed circuit board 21 wherein the other end of the modular electrical connector 10 may be attached, e.g. screwed, to the base 29.

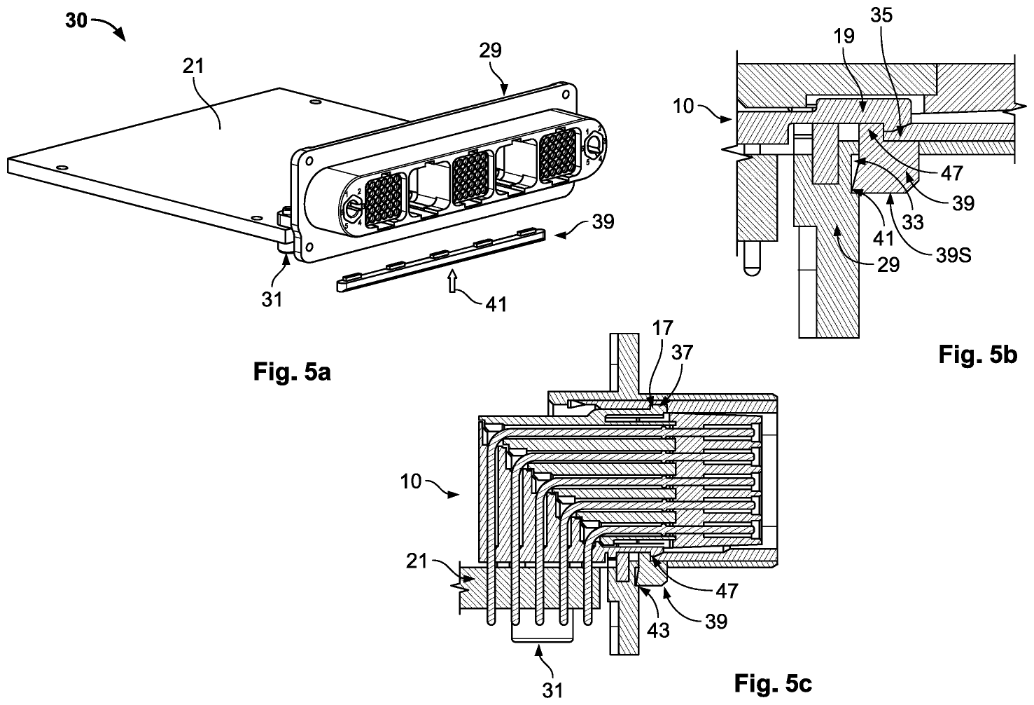

FIG. 4b illustrates a side view of the sub-ensemble/sub-assembly 30 shown in FIG. 4a, according to the present disclosure. In FIG. 4b, the printed circuit board 21 and the base 29 have been attached to each other by screws 31. FIG. 4b further illustrates, that in this example the upper clipping lug 17 of the module 10 shown in FIG. 4b fits into a recess/groove 37 of the base 29. Thus, the interplay between the upper clipping lug 17 and the recess 29 would be a normal one. For the lower clipping lug, however, when comparing with element 19 of FIG. 1, this type of hooking has been modified; FIG. 4b illustrates a trench 35 of the base 29, which at least partly reaches through the base 29 into the cavity of the base 29, i.e. its housing. Further, FIG. 4b illustrates a further groove 33, which is provided in the base 29, but at a position angled by 90 degrees with respect to the groove 33. This will be further discussed with regard to FIG. 5a.

FIG. 5a illustrates the sub-assembly 30 of FIG. 4b, with a clipping bar 39, according to the present disclosure. The clipping bar or clipping strip 39 may be molded or it may be made of bent and/or folded sheet metal. The material of the clipping bar 39 may be chosen according to the needs or the circumstances.

An arrow 41 indicates a direction of fitting the clipping bar 39 into the base 29. More precisely, the clipping bar 39 is meant to fit into the trench 35, as is further detailed in FIG. 5b which illustrates a side view of the sub-assembly 30 plus clipping bar 39 of FIG. 5a. The clipping bar 39 may be fit into trench 35 by clamping or snap-fitting. Thus, by snap-force the clipping bar 39 will be secured in trench 35. As shown in FIG. 5b the clipping bar 39 fills the trench 35 and thus also blocks retracting the module 10 from the cavity of the housing of the base 29, since the lower clipping lug 19 is now blocked or hooked against the clipping bar 39 fit into the trench 35. That is, the clipping bar 39 would typically remain clipped or clamped in its respective trench 35 by force; e.g., it is force-fitted into the trench 35.

Additionally or alternatively, there may be further clipping devices such as recesses etc. other than just the trench 35, into which the clipping bar 39 may be clipped for securing it to the housing. FIGS. 5b and 5c illustrate a further strip or bar stop 47 or of clipping bar 39, filling and fitting into the trench 35 to stop lower clipping lug 19.

For further securing clipping bar 39 into the trench 35, FIGS. 5b and 5c further detail an additional form of precaution for securing the clipping bar 39 with respect to the base 29. The clipping bar 39 may be provided with an additional protrusion 41. The additional protrusion 41 may be configured to snap-fit, e.g. click into a corresponding groove 33 of base 29. The additional protrusion 41 may have a shape of a nose or hook or a tiny harpoon. The corresponding groove 33 is provided perpendicular to the trench 35, in the base 29. Thus, as illustrated in FIG. 5c, by arrow 43, clipping bar 39 may pre-click or snap-fit or hook into groove/recess 33, which provides an additional security for the clipping bar 39 so that it may not easily be removed from trench 35. It should be understood that, for releasing clipping bar 39 from groove/recess 33, it may be bent into the opposite direction of arrow 43, or likewise, perpendicular and away from groove 33.

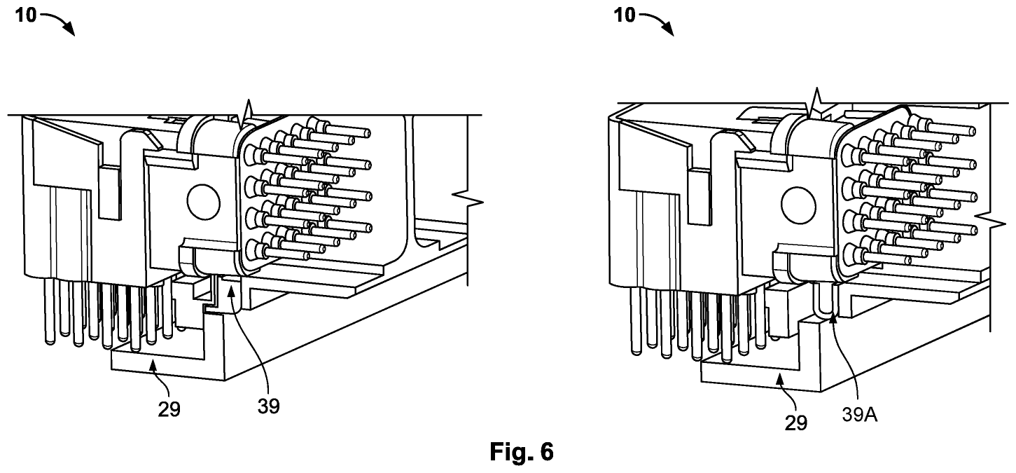

FIG. 6 illustrates two different forms of the clipping bar 39, according to the present disclosure. On the left side, the clipping bar 39 is shown in a molded form, as was used in FIGS. 1-5c, above. Alternatively, FIG. 6 illustrates, on the right side, a clipping bar 39A may also be provided made of metal, e.g. in a bent form. Thus, a clipping bar 39 or 39A may be provided according to circumstances.

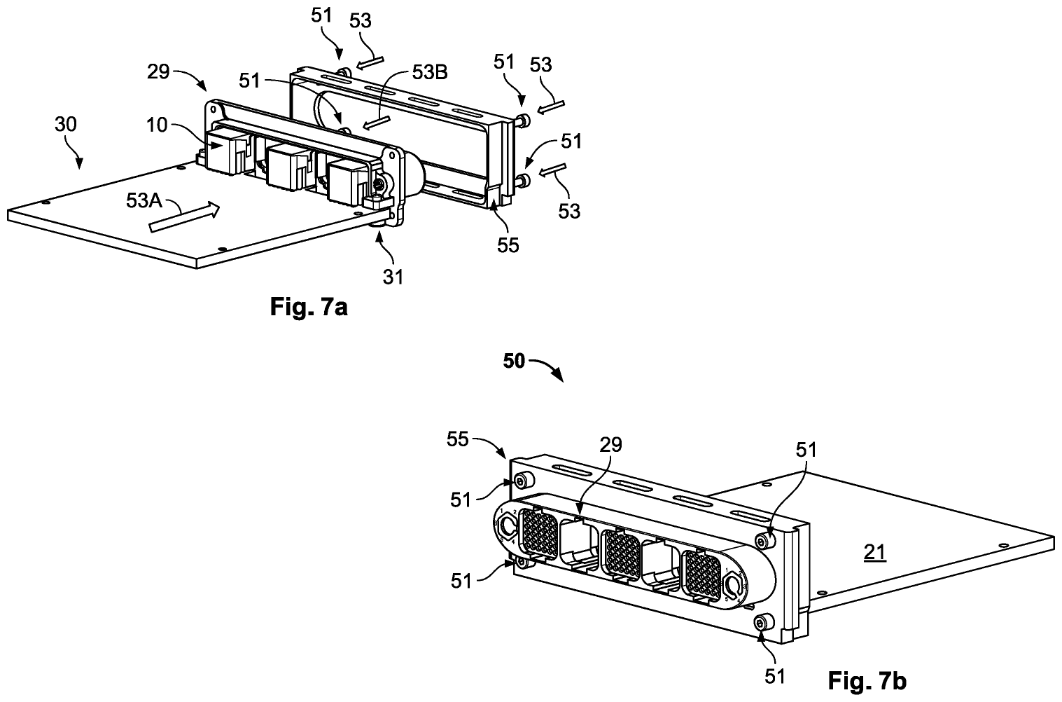

FIG. 7a illustrates the sub-ensemble 30 to be fit together, i.e. into a frame 55 as a retaining part, according to the present disclosure. The frame 55 may be a frame of an electronic box. Arrows 53A and 53B indicate the directions of fitting together the respective elements 30 and 55. The connection/attachment of sub-ensemble 30 and frame 55 may be accomplished by screws 53 or other fixation devices. FIG. 7a indicates four screws 53 in the shown embodiment. The frame 55 may also be referred to as a fastening frame.

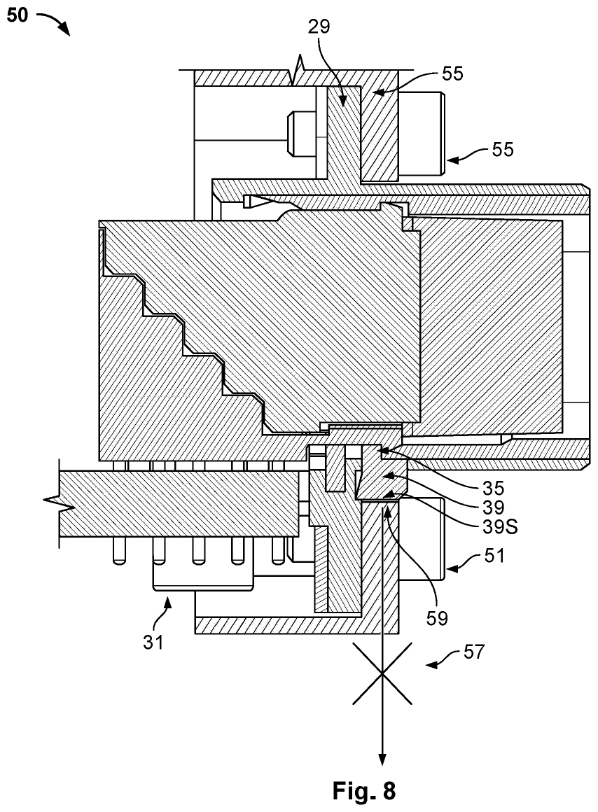

FIG. 7b illustrates assembly 50, i.e. the sub-assembly 30 of FIG. 7a, fit together with frame 55, according to the present disclosure. The effect of the frame 55 with respect to the above-discussed elements of the sub-assembly 30 and the clipping bar 39 are further illustrated in FIG. 8. Thus, the retaining part may be an additional fastening frame 55 which will cover, from the outside at least the mating housing and the cavity of the mating housing. In other words, it may be releasable imposed onto the mating housing, i.e. the mating housing may be attached to or detached from said fastening frame 55.

FIG. 8 illustrates the assembly 50 of FIG. 7b, detailing the clipping bar 39, according to the present disclosure. Further to the elements and discussions of FIGS. 5a-5c, 7a-7b, FIG. 8 illustrates that the clipping bar 39, which is provided into the trench 35 and pre-clipped into the groove 33, as were detailed for FIGS. 5a-5c, has a surface 39S. The surface 39S faces away from the trench 35, as shown in FIG. 8. In FIG. 8, the frame 55 of an electronic box is attached, i.e. screwed to the sub-assembly 30, c.f. FIGS. 7a and 7b. The surface 39S abuts or contacts a surface 59 of the frame 55 such that frame 55, by the surface 59, blocks removal of the clipping bar 39 from the trench 35. Thus, the frame 55, having surface 39S, provides an additional securing of the clipping bar 39 in the trench 35. As indicated by the crossed arrow 57, which is shown solely for illustrational purposes, this removal of clipping bar 39 is blocked. It should be understood that this blocking effect might be easily lifted once the frame 55 is unscrewed from the sub-assembly 30.

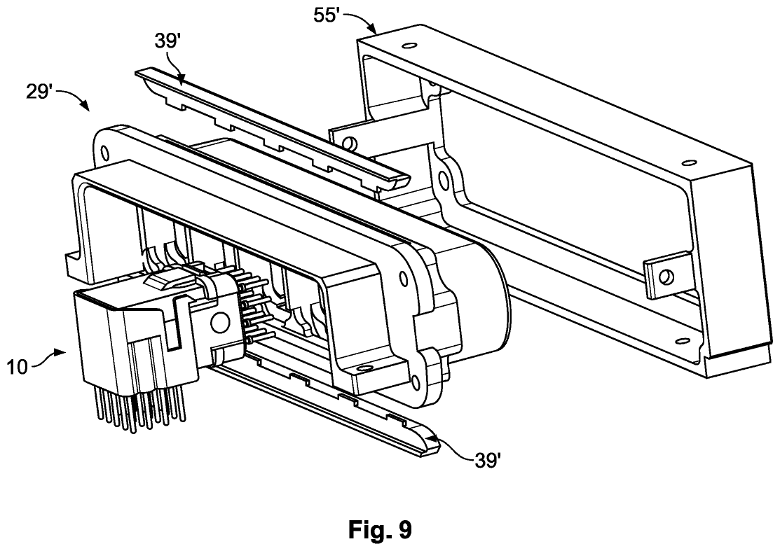

FIG. 9 illustrates another example of applying clipping bars according to the present disclosure. In FIG. 9, unlike in the previous Figures, there are two clipping bars 39′, which may be used to secure a connector module 10 to a base 29′. Similar to FIG. 8, a frame 55′ may provide additional securing of the respective clipping bars 39′.

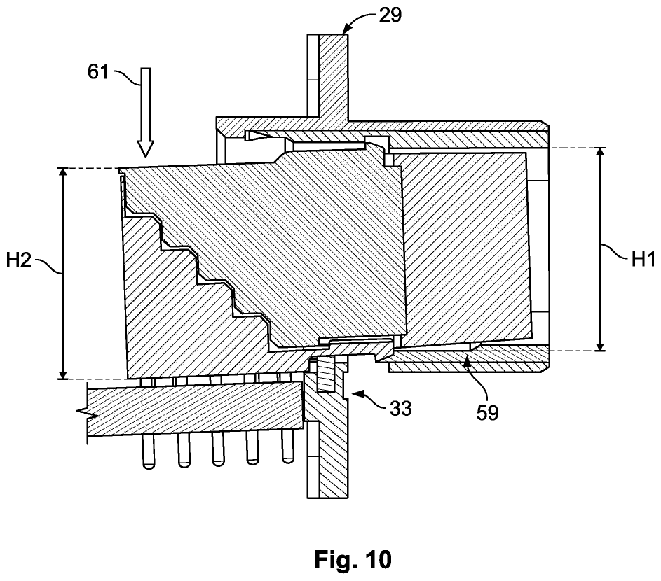

FIG. 10 illustrates releasing and unhooking the electrical connector module 10 from the cavity of the housing of the base 29, according to the present disclosure. In FIG. 10, the frame 55 of the electronic box, as was shown in FIG. 8 or 9 has already been removed. Further the clipping bar 39, as was discussed in the previous FIGS. 5a-9 has been removed. In that respect, FIG. 10 resembles FIG. 4b. In FIG. 10, it is further illustrated that the width/height of the cavity of the housing of base 29 has a height H1. Said height H1 is a few tenths of a millimeter larger than a corresponding height H2 of the module 10. Thus, after removing the securing devices 39 and 55, respectively, the module 10 may be unplugged from the base 29 more easily by applying pressure, i.e. a force along arrow 61, as indicated in FIG. 10, thus, the LP module 10, as illustrated with FIGS. 1-10 can be both safely and easily secured to a cavity of a housing as well as safely and easily removed from said cavity of the housing.

The present disclosure further provides a method of manufacturing an assembly 50 comprising, providing a sub-ensemble 30 comprising a modular electrical connector 10 attached to a printed circuit board 21 and a base 29, respectively; mounting the modular electrical connector 10 into a cavity of a housing of the base 29; providing one or more clipping bars 39 and releasably securing the modular electrical connector 10 into the cavity of the housing by the clipping bar 39; wherein the clipping bar 39 may be inserted into a corresponding trench 35 of the housing and abuts against a respective clipping lug 17 of the modular electrical connector 10.

The solution according to the present disclosure makes it possible to remove an electrical connector such as an LP (Low Profile) module from its cavity, which is very difficult presently because the snap-on tabs are too rigid to be removed from their respective snap-on grooves, even with tooling. In addition, the lower lug of existing solutions may be difficult to access due to the angled contacts.

The solution according to the present invention is to secure the electrical connector modules 10 in their respective cavity with a removable clipping strip/bar 39. The bar/strip 39 can be made of molded composite or metal. The clipping bar 39 may be positioned from the outside of the case in a trench 35 and is held in place by clamping or clipping and/or by a fixing part, e.g. a fixing frame 55 of the electronic box. In order to facilitate the disassembly of the modules 10, the cavity receiving the module 10 may be free in its inner part over its entire width or diameter over a few tenths of a millimeter in height. Thus, the cavity of the housing is just a few tenths of a millimeter wider that the part of the electrical connector 10 received in it. This makes it possible, after dismantling the clipping bar/strip 39, to unhook the upper clipping lug 17 from the module 10 by tilting the module 10 downwards. Thus, by providing at least one clipping bar, the present disclosure provides a means for securing the electrical connector, e.g. an LP module 10, to a cavity of a mating housing which also serves as permitting release of electrical connector 10 from said mating housing after releasing and/or removing the clipping bar 39. The printed circuit boards 21 onto which the electrical connector module 10, e.g. the LP module, is soldered may be taken out, replaced or repaired, which may not be possible when the electrical connector modules 10, e.g. the LP modules cannot be unclipped from their housing; this will also greatly reduce the cost of maintenance.

Although the embodiments have been described in relation to particular examples, the invention is not limited and numerous alterations to the disclosed embodiments can be made without departing from the scope of the present disclosure. The various embodiments and examples are thus not intended to be limited to the particular forms disclosed. Rather, they include modifications and alternatives falling within the scope of the claims and individual features can be freely combined with each other to obtain further embodiments or examples according to the present disclosure.

What is claimed is:

1. An assembly, comprising:
an electrical connector module to be mounted into a cavity of a housing; and a clipping bar securing the electrical connector module when mounted in the cavity of the housing, the clipping bar inserted into a trench of the housing and abutting against a clipping lug of the electrical connector module, the clipping bar is releasably secured in the trench.

2. The assembly of claim 1, wherein the clipping bar is secured in the trench by clamping and/or clipping and/or by a retaining part.

3. The assembly of claim 2, wherein the retaining part is a fastening frame into which the housing is received.

4. The assembly of claim 1, wherein the clipping bar is molded or is made of a sheet metal.

5. The assembly of claim 4, wherein the sheet metal is bent or folded.

6. The assembly of claim 1, wherein a first end of the electrical connector module is soldered onto a printed circuit board.

7. The assembly of claim 6, wherein a second end of the electrical connector module is attached to a base to form a sub-assembly, the base having the housing.

8. The assembly of claim 7, wherein the clipping bar has a protrusion that protrudes perpendicular to the clipping bar.

9. The assembly of claim 8, wherein the clipping bar is snap-fittable into a groove of the base with the protrusion.

10. The assembly of claim 9, wherein a retaining part is attached to the base of the sub-assembly.

11. The assembly of claim 10, wherein the retaining part has a surface abutting the clipping bar and blocking the clipping bar when the retaining part is attached to the sub-assembly.

12. The assembly of claim 1, wherein the cavity of the housing receiving the electrical connector module is wider than the electrical connector module.

13. A method of manufacturing an assembly, comprising:
providing a base and a sub-assembly including an electrical connector module attached to a printed circuit board;
mounting the electrical connector module into a cavity of a housing of the base;
providing a clipping bar; and
releasably securing the electrical connector module in the cavity of the housing with the clipping bar, the clipping bar is inserted into a trench of the housing and abuts against a clipping lug of the electrical connector module.

14. The method of claim 13, wherein providing the sub-assembly includes soldering a first end of the electrical connector module onto the printed circuit board and attaching a second end of the electrical connector module to the base.

15. The method of claim 13, wherein then clipping bar is secured in the trench by clamping and/or clipping and/or by a retaining part.

16. The method of claim 15, wherein the clipping bar is molded or is made of a sheet metal.

17. The method of claim 15, wherein the retaining part is a fastening frame of a housing.

18. The method of claim 17, further comprising mounting the sub-assembly into the fastening frame, the fastening frame is attached to the base of the sub-assembly.

19. The method of claim 13, wherein the clipping bar has a protrusion that protrudes perpendicular to the clipping bar, the clipping bar is snap-fit into a groove of the base with the protrusion.

20. The method of claim 15, wherein the retaining part has a surface abutting the clipping bar and blocking the clipping bar when the retaining part is attached to the sub-assembly.
